(19) United States
(12) Patent Application Publication
(10) Pub. No.: US 2005/0005338 A1
(43) Pub. Date: Jan. 13, 2005

(54) Multipurpose hand protection device

(76) Inventor: Latasha E. Lewis, Atlanta, GA (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/615,854

(22) Filed: Jul. 10, 2003

(51) Int. Cl. A41D 13/00; A47J 45/10

(52) U.S. Cl. 2/20

(57) ABSTRACT

The invention as disclosed herein provides a hand protection device that protects the hand of a user from inflicting self injury to the hand while handling a sharp agent. The hand protection device includes a gripping portion and a flange portion. The outer surface of the flange portion is made of a cut resistant material and the gripping portion is made of a flexible and grip-enhancing material. The flange covers the exterior parts of the index finger, the thumb, and the area in between the index finger and the thumb of the user.

### FIELD OF THE INVENTION

This invention relates to a device for protecting hands. In particular, the invention relates to a flexible multipurpose hand protection device that protects the hand from injury by sharp implements such as syringe needles.

### BACKGROUND OF THE INVENTION

Numerous devices are described in the prior art that purport to protect a user's hand from injury when the user is engaged in various activities. Generally, these devices include a pad or covering that is positioned over the user's palm, or back of the hand and often the inner finger surfaces, and some means for securing the device to the user's hand during use. These devices typically include a soft component to place near the skin and a hard, shell-like outer cover. The soft component is intended not only to provide a cushion, but also to accommodate itself to the varying configurations and sizes.

For example, U.S. Pat. No. 6,226,795 to Winnigham describes a custom-fitted hand protection product comprising a protective pad that includes a flexible inner cushion layer for positioning on the back of the hand, and a flexible intermediate layer that is impregnated with a moisture-curable resin which hardens upon curing to form a rigid structure.

U.S. Pat. No. 2,205,957 to Kinkis describes a hand shield comprised of a flexible, rectangular sheet-like material that includes a slot parallel to one end. When used, the user's hand is pushed or forced through the slot, and the sheet-like material is positioned over the user's palm. The Kinkis device is used primarily during handling of materials such as tin or steel sheets, plate glass, bricks, or the like.

U.S. Pat. No. 4,873,998 to Joyner describes a protective surgical hand covering equipped with a hardened mold material situated over selected regions of the hand. The hardened material covers portions of the palm, the knuckles, and the lower knuckles. Thimble-shaped tips formed of the hardened mold material can be placed over the fingers. Surgical latex gloves may be worn either over or under the protective surgical hand covering.

The prior art devices, however, are primarily adapted to be worn by the user during the entire time that the user is engaged in the activity involving handling of sharp objects. Accordingly, these devices are primarily designed to ensure that the device remains securely on the user's hand. Additionally, a vast majority of the prior art devices are too rigid and cumbersome to wear and do not allow dexterity.

Certain activities involve tasks of short duration during which it is necessary to cover the hand for a short period of time, separated by periods when it is necessary to free the hand for other activities. In such instances, the prior art devices are inconvenient to use, due to the difficulty and time required to put the device onto the hand, and remove it during times when it is not needed. An inexpensive device that provides protection for a user's hand, while also being easy to remove would be of considerable value.

The present invention as described herein permits and overcomes these and other problems with the prior art devices by providing a multipurpose hand protection device that is efficient, easy to use and allows dexterity.

### SUMMARY OF THE INVENTION

The invention, as disclosed and described herein, provides a hand protection device that protects the user from a self-inflicting injury. In particular, the hand protection device of the invention protects the hand of a user from being pierced or cut by a sharp agent while handling the sharp agent. The invention comprises a gripping portion and a flange portion. The flange portion is made of a cut resistant material and the gripping portion is made of a flexible and/or grip-like material. The flange covers the exterior parts of the index finger, the thumb, and the area in between the index finger and the thumb of the user.

In one embodiment, the flange is flexible and conforms to the shape of the area of the hand of the user that is being protected.

In yet another embodiment, the inner surface of the flange is made of a textured material to increase gripping activity with the hand.

In another embodiment, the hand protection device further comprises one or more means for enhancing the grip for retaining the device in a desirable position on the hand of the user. The releasable attachment means comprise, for example, finger loops or finger pockets on the gripping portion of the device.

The hand protection device of the invention protects the hand of the user from sharp agents such as, for example, knives, needles, scissors, and scalpers, among others. The objects that are subjected to the sharp agents comprise, for example, laboratory vessels, body parts during surgery, food items, such as meat, fish, and vegetables, and hair during hair dressing, among others. The laboratory vessels include test tubes, cuvets, plates, beakers, flasks and slides, among others.

The flange is made in various shapes subject to the intended activity of the user. For example, for holding a cylindrical vessel or holding meat and vegetables to cut, a semi-circular space is created between the thumb and the index finger. Accordingly, in one embodiment, the flange is made in a semi-circular shape.

The invention provides a hand protection device comprising a substantially impenetrable flange, the outer surface of the flange being made of a penetration-resistant material. The flange is positioned on the wearer's hand covering the upper extremity of the hand as the wearer grips objects; that is, it covers exterior parts of the index finger, the thumb and the area in between the index finger and the thumb.

These and other aspects and embodiments of the invention are disclosed in detail herein.

### BRIEF DESCRIPTION OF THE FIGURES

FIG. 1 is a perspective view of one embodiment of the hand protections device.

FIG. 2A is a perspective view of a second embodiment of the hand protection device.

FIG. 2B is a perspective view of the hand protection device shown in FIG. 2A.

FIG. 3 is a top plan view illustrating the use of the hand protection device for gripping objects, vessels and the like.

FIG. 4 is a perspective view of a further embodiment of the hand protection device having a grip-enhancing surface.

FIG. 5 is a perspective view of a further embodiment of the hand protection device having gripping aids.

FIG. 6 is a perspective view of a further embodiment of the hand protection device having gripping slots.

FIG. 7 is a perspective view of a further embodiment of the hand protection device having grip loops.

### DETAILED DESCRIPTION OF THE INVENTION

This invention relates to a multipurpose hand protection device. The invention has application in any field or industry which requires or makes desirable wearing a resilient (i.e, non-penetrating, non-piercing) and flexible hand protection. The industries or fields intended to benefit from this invention include, by way of example and not limitation, medicine, sport, food, hair dressing, and clothes swing), among others. The practitioners in these industries can expose themselves to injury with sharp objects such as knives, scalpers, scissors, needles, etc.

Traditionally, the medical practitioner will hold the laboratory vessel, such as, for example, test tubes and cuvets, by one hand, while injecting a liquid sample through the use of a needle and a syringe by the other hand. During this work, the area of the hand around the laboratory vessel is subject to the risk of being pierced by the needle. While latex gloves afford some protection, especially from allowing the skin to contact the subject being cut or a liquid sample, these gloves will not insure against self-wounding by the worker. The generally thin pliable latex gloves commonly worn by medical practitioners allow for a high degree dexterity, but are quite thin. These latex gloves generally will not withstand piercing by instruments such as surgical scalpels or needles.

In view of the above, the protective hand device of the invention has two important characteristics. First, it is rigid enough so that the upper extremity of the hand is protected from being cut or pierced during work. Second, it permits a range of flexibility and dexterity, to allow the technician wearing the device to perform routine procedures. This combination has been quite difficult to achieve. The invention makes it possible for a glove wearer to protect the requisite parts of the hand no matter what kind of glove is being worn. For this reason, the wearer can combine the hand protection according to the invention with customized gloves, and other gloves for which customized hand protection is unavailable.

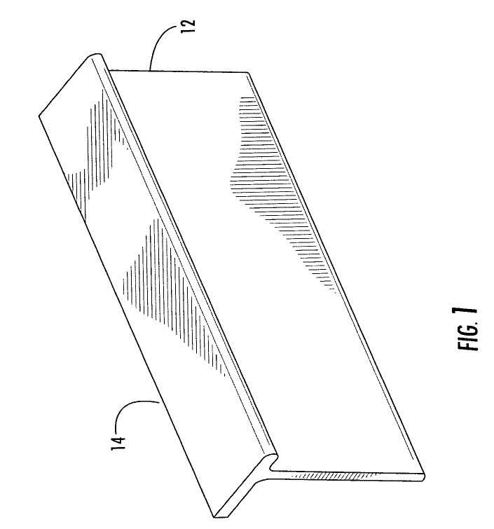

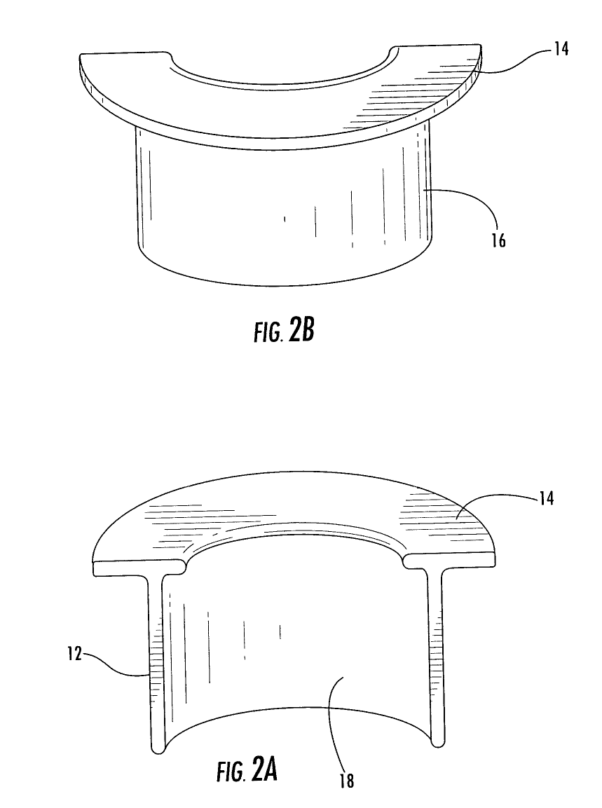

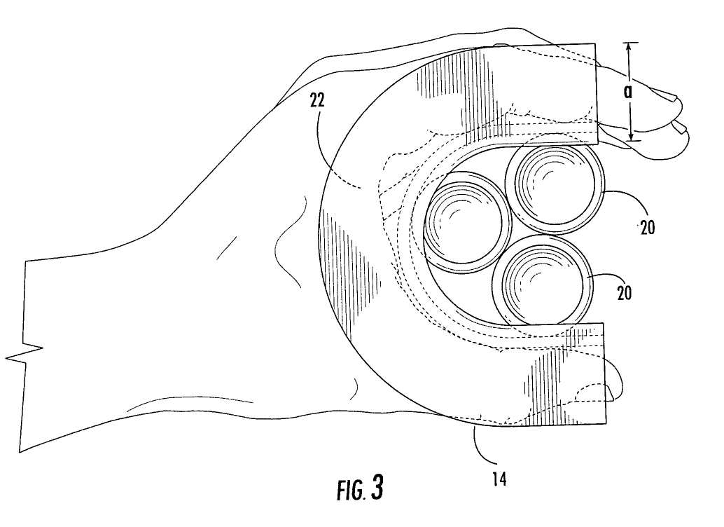

Referring to FIG. 1, the hand protection device comprises, in its simplest form, a flexible gripping portion 12 and a protective flange portion 14. The gripping portion 12 has two sides. The first side 16 of the gripping portion (See FIG. 2B) is the surface that fits within and is grasped by the palm of the hand (see FIG. 3). The second side 18 of the gripping portion is used to grasp vessels 20 or other objects within the hand, as shown in FIG. 3.

The gripping portion 12 should be a pliable material that affords a substantial friction grip surface on both sides. The palm of the hand should engage the first side 16 of the gripping portion such that the protective device does not slip or slide around in the palm just prior to grasping one or more objects with the second side 18 of the gripping portion. A very flexible and malleable substance such as neoprene would provide such a gripping surface on both sides of the gripping portion. Other substances having the necessary properties are equally useful.

Referring to FIG. 3, in use the flange portion 14 provides a semi-circular shaped surface in a generally horizontal plane that is intended to rest upon, cover and protect the upper extremity of the user's hand when gripping vessels or other objects. FIG. 1 shows an embodiment of the hand protection device according to the invention in its natural state prior to use. This form of the device could be made provided that the material of the flange 14 is sufficiently flexible to curve into the semi-circular shape shown in FIG. 3 for gripping objects. If the flange portion 14 is not sufficiently flexible because its penetration protection requires a less flexible material, then the device may be formed as shown in FIGS. 2A and 2B so that little deformation is necessary to place the hand around the gripping surface and squeeze for grasping objects 20 with the second surface of the gripping portion, as shown in FIG. 3. In each illustration, the flange portion is shown in a substantially normal relation (that is, arranged at approximately a ninety-degree angle) to the gripping portion.

Referring to FIG. 3, the flange portion should comprise a sufficient horizontal dimension a to provide complete or nearly complete coverage of the upper extremity of the user's hand while the hand grips objects 20. Used as shown in FIG. 3, the hand protection device of the present invention affords total protection for the upper surface 22 of the hand while it grasps objects 20, such as test tubes or sample vessels. If it is necessary for a nurse or technician to insert a syringe needle into the objects 20, the flange portion 14 prevents a misdirected needle or other sharp implement from inadvertently piercing the wearer's hand.

The hand protection device of the invention is generally made out of a material which has substantial density to be non-pierceable and yet allow enough flexibility to move the hand and to permit dexterity of the hand. The material from which the device may be made includes polyethylene, polyurethane or polypropylene, and may include materials such as nylon, PVC, leather, molded thermoplastic, a natural or synthetic fabric having a pore size smaller than the size of diameter of a needle, or a combination thereof, among others.

Also encompassed within the scope of the invention is a hand protective device comprising a flange having an inner surface made of a pliable and flexible material. The pliable and flexible material may be composed of, for example, tightly interlaced fibers or filaments, interwoven high density nylon that can grip the hand, or any other material that is has flexibility and gripping-like characteristics.

Because of the choice of material and the efficient configuration of the flange, the wearer's hand is not smothered in areas not requiring protection or coverage; hence, the wearing of the protection is not attended by discomfort due to perspiration or hairs trapped behind an unduly large hand protection device. Because the device is quickly and easily gripped, used and released, it is much less cumbersome and is easier to use than gloves while affording a high level of protection against accidental penetrations. As shown in FIGS. 1, 2A, 2B and 3, the hand protective device may be used by either right- or left-handed persons.

Alternate embodiments of the invention are shown in the following illustrations, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

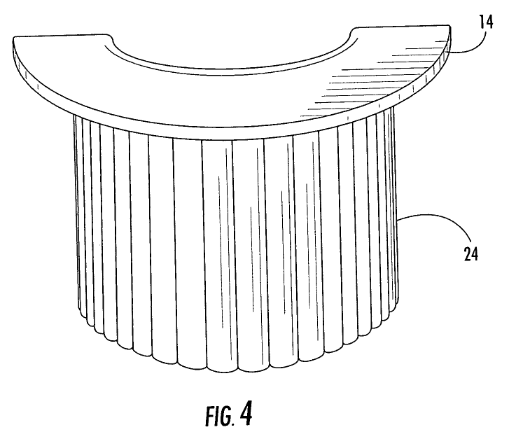

To facilitate a better grip on the protective device, means for enhancing the grip of the hand to the first surface 16 of the device can be provided. FIG. 4 illustrates a ribbed formation 24 of the second surface 16 to afford an enhanced gripping characteristic. Other grip-enhancing textured surfaces, such as a pebbled surface or a honey-comb surface, may be employed while remaining within the scope of the invention.

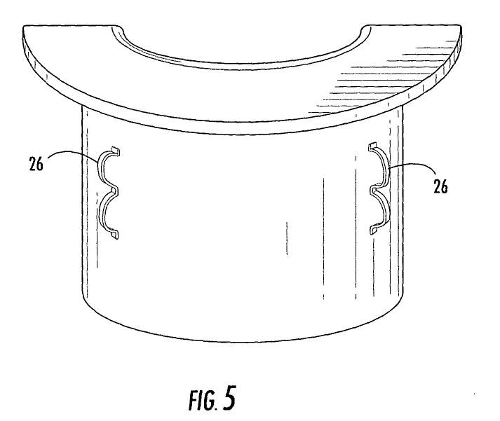

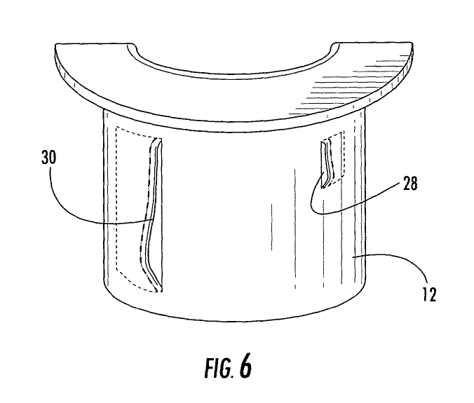

FIG. 5 illustrates the addition of finger loops 26. FIG. 6 illustrates a thumb pocket 28 and a finger pocket 30 provided in the first surface of the gripping portion 12 of the device. Each of these means for enhancing the grip provides a way to better secure the hand grip on the device prior to grasping objects with the second gripping surface. The ribbed embodiment of FIG. 4, other textured-surface configurations, and the finger loop embodiment of FIG. 5 can still be used by either right- or left-handed individuals. The finger and thumb pocket embodiment of FIG. 6 may require right- and left-handed versions of the device.

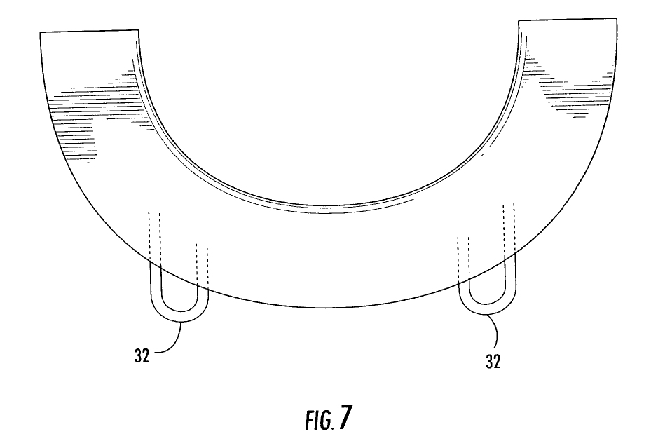

The means for gripping the hand protection device may be quite minimal. FIG. 7 illustrates an embodiment wherein the gripping portion of the device comprises only finger-straps 32. The finger-straps 32 are attached directly to the underside of the flange portion. In this form, the user merely inserts her fingers into the finger-straps and squeezes the flange portion into a “cupped” gripping shape while grasping objects within the palm of the hand. The flange protects the upper extremity of the hand and fingers from accidental harm while the palm of the hand remains remote from any possibility of penetration. Other means for gripping can be employed in this embodiment of the invention, including finger cups rather than straps, and other equivalent forms.

While much of this description has been oriented to medical or laboratory uses of the hand protection device, the present invention has application in various fields. For instance, the device may afford protection during the use of various hand tools that threaten injury by accidental penetration. Examples are screwdrivers, chisels, knives and the like. The device of the invention is useful for protection against injury to the upper extremity of the hand while gripping any object that may require adjustment, penetration, fastening and similar work.

Numerous variations in the construction of the hand protection device of this invention, within the scope of the appended claims, will occur to those skilled in the art, in the light of the foregoing disclosure.

1. A hand protection device for protecting a wearer's hand from injury, comprising:
a gripping portion and a flange portion,
said gripping portion having first and second gripping surfaces, said first gripping surface providing a surface for engaging the wearer's hand, said second gripping surface providing a surface to engage objects grasped within the wearer's protected hand,
said flange portion extending substantially normal to the gripping portion and covering the upper extremity of the wearer's hand, said flange portion being substantially resistant to accidental penetration by sharp implements.

2. The hand protection device of claim 1, wherein
the gripping surface comprises a textured surface configuration to enhance the gripping characteristic of the gripping surface.

3. The hand protection device of claim 1, wherein
the gripping surface further comprises one or more finger loops in which to secure one or more of the wearer's fingers while gripping the device.

4. The hand protection device of claim 1, wherein
the gripping surface further comprises one or more finger pockets in which to secure one or more of the wearer's fingers while gripping the device.

5. The hand protection device of claim 1, wherein
the flange portion comprises a material that is substantially resistant to penetration by sharp implements.

6. A hand protection device for protecting a wearer's hand from injury, comprising:
a means for gripping the device and a flange portion,
said flange portion extending substantially normal to the gripping means and covering the upper extremity of the wearer's hand, said flange portion being substantially resistant to accidental penetration by sharp implements.

7. The hand protection device of claim 6, wherein
the gripping means comprises one or more finger loops attached to the flange portion.

8. The hand protection device of claim 6, wherein
the gripping means comprises a textured surface extending substantially normal from the flange portion, said textured surface providing a gripping surface for the wearer's hand.

9. The hand protection device of claim 6, wherein
the gripping means comprises one or more finger pockets in a gripping surface that extends substantially normal from the flange portion.

10. The hand protection device of claim 6, wherein
the gripping means comprise one or more finger loops on a gripping surface that extends substantially normal from the flange portion.
